(19) United States
(12) Patent Application Publication
(10) Pub. No.: US 2008/0303636 A1
(43) Pub. Date: Dec. 11, 2008

(54) SECURE SYSTEM FOR TRACKING GOODS

(75) Inventors: Fabien CHATTE, Nogent Sur Marne (FR); Bruno Fabre, Cavaillon (FR); Dennis Gilham, Essex (GB); Guy Venture, Senas (FR)

Correspondence Address: SUGHRUE MION, PLLC, 2100 PENNSYLVANIA AVENUE, N.W., SUITE 800, WASHINGTON, DC, 20037, US

(73) Assignees: NEOPOST TECHNOLOGIES, French Limited Company, Bagneux (FR); NBG ID, French Simplified Joint Stock Company, Cavaillon (FR)

(21) Appl. No.: 12/015,716

(22) Filed: Jan. 17, 2008

(30) Foreign Application Priority Data
Jan. 26, 2007 (FR) 0752920

(51) Int. Cl. H04Q 5/22

(52) U.S. Cl. 340/10.41

(57) ABSTRACT

A secure system for tracking goods loaded on a delivery vehicle having a driver's cab and at least one container, said driver's cab being provided with a first RFID transponder disposed on any wall of said cab, and each of the containers is provided with at least two RFID transponders, one of which is disposed on any wall of said container and the other of which is disposed on each of the delivery doors of said container, each of said RFID transponders being designed to co-operate with a RFID reader/interrogator integrated into a mobile telephone of the driver of the vehicle, said mobile telephone being in communication with a management server via a mobile communications network.

### FIELD OF THE INVENTION

The present invention relates to the field of logistics and of transporting miscellaneous goods, and it relates more particularly to tracking such goods while they are being transported.

### PRIOR ART

In order to know, at any time, the position of a delivery vehicle and thus of the goods that are on board it, it is known that the vehicle can be equipped with a Global Positioning System (GPS). However, in addition to a GPS being a costly system, it is generally present only in the cab of the tractor vehicle and not in the semi-trailer or in the trailers that said tractor vehicle might be pulling. As a result, if, for example, the semi-trailer or the trailers are stolen, while the tractor is separated from them, and if they are then hitched up to another tractor vehicle, it becomes impossible to know where the goods are because, for the GPS, the vehicle is still located at the same place as its tractor.

### OBJECT AND DEFINITION OF THE INVENTION

An object of the present invention is to mitigate that drawback by proposing a system that is both simple and inexpensive for automatically tracking goods while they are being transported by a delivery vehicle.

This object is achieved by a secure system for tracking goods loaded on a delivery vehicle having a driver's cab and at least one container, wherein said driver's cab is provided with a first Radiofrequency Identification (RFID) transponder disposed on any wall of said cab, and each of said at least one containers is provided with at least two RFID transponders, one of which is disposed on any wall of said container and the other of which is disposed on each of the delivery doors of said container, each of said RFID transponders being designed to co-operate with a RFID reader/interrogator integrated into a mobile telephone of the driver of the vehicle, said mobile telephone being in communication with a management server via a mobile communications network.

Thus, the use of a mobile telephone in place of a GPS makes it possible to track the goods with precision throughout their transportation and to be informed immediately of any disappearance of said goods.

Said RFID transponder disposed on the delivery door has an antenna circuit mounted where the two flaps of said door meet so as to give information as to whether said door is in an open state or in a closed state.

Preferably, said mobile telephone includes means for automatically sending a short message to said management server, through said mobile communications network, when at least one of said RFID transponders does not respond to interrogation by said RFID reader/interrogator. Said interrogation is performed periodically, e.g. every five seconds.

Advantageously, said RFID reader/interrogator includes means for automatically recognizing said RFID transponders present within its communication range and for validating only those RFID transponders that are associated with said delivery vehicle.

The invention also provides a method of tracking goods loaded on a delivery vehicle having a driver's cab and at least one container, said method comprising the following steps:

periodically interrogating RFID transponders via a RFID reader/interrogator incorporated in a mobile telephone of the driver of the vehicle, a first one of said RFID transponders being disposed on any wall of said cab, and at least two of said RFID transponders being disposed in said at least one container, one of said at least two of said RFID transponders being disposed on any wall of said container and the other of said at least two of said RFID transponders being disposed on each of the delivery doors of said container; and

automatically sending a short message to a management server, through a mobile communications network when at least one of said RFID transponders does not respond to said periodic interrogation by said RFID reader/interrogator.

Preferably, said short message corresponds to at least one of the following messages: “trailer rear door open”, “vehicle out of range”, or “trailer(s) out of range”.

The method may further comprise an additional step of causing the management server to send an information request short message to the mobile telephone of the driver of said vehicle after said short message indicating that the vehicle or at least one container is out of range has been received.

Advantageously, the method further comprises an initial step for automatically recognizing said RFID transponders present within the communication range of said RFID reader/interrogator and for validating only those RFID transponders that are associated with said delivery vehicle. In said initial step, the driver receives a short message indicating to the driver the list of the RFID transponders that the driver's telephone should read in said periodic interrogation step.

### BRIEF DESCRIPTION OF THE DRAWINGS

The characteristics and advantages of the present invention appear more clearly from the following description given by way of non-limiting indication and with reference to the accompanying drawings, in which:

FIG. 1 is a diagrammatic view of a secure goods-tracking system of the invention; and

FIG. 2 shows the various steps of the secure tracking method implementing in the system of FIG. 1.

### DETAILED DESCRIPTION OF A PREFERRED EMBODIMENT

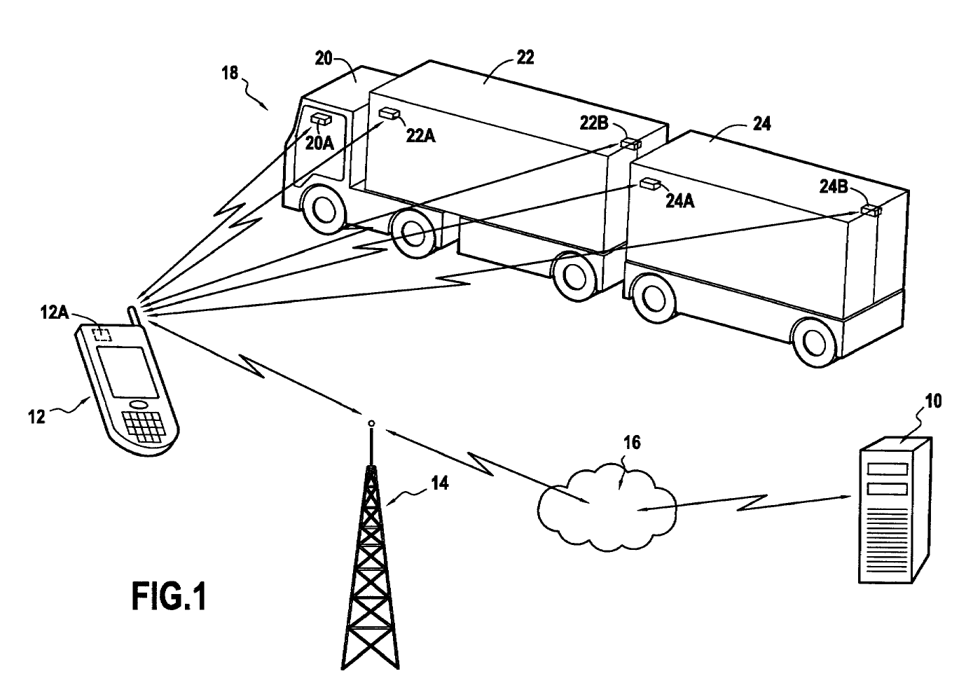

FIG. 1 is a highly diagrammatic view of a communications system of the invention that makes it possible to track goods in secure manner while they are being transported to their recipients by delivery vehicles of the semi-trailer type or of the multiple-axle heavy goods vehicle type.

This system is organized around a management server 10 that is in radio communication with mobile telephones 12 via mobile relay stations 14 of a cellular communications network 16. This network is a mobile network of known type, namely of one of the following types: second or third generation Global System for Mobile Communications (GSM), Enhanced Data GSM Environment (Edge), Universal Mobile Telecommunications System (UMTS) or some equivalent type. However, it is also possible to imagine using a WiFi/WiMAX network. The mobile telephone includes an integrated RFID reader/interrogator 12A designed to co-operate with RFID transponders disposed in a goods delivery vehicle 18 whose driver possesses the mobile telephone. More particularly, the vehicle, which is, for example, a four-axle vehicle comprising a tractor with its cab 20 and two trailers 22, 24, is equipped with five RFID transponders, one on the tractor and two on each trailer. The RFID transponder disposed on the tractor 20A and one (22A, 24A) of the two RFID transponders disposed on each of the trailers serve to identify (and to verify the presence of) the corresponding portion of the vehicle, while the other RFID transponder 22B, 24B on each trailer is positioned on the rear delivery door of the trailer so as to give information on the state (open or closed) of the rear door. Thus, by periodically detecting the identification and rear door transponders, it is possible to make sure that the trailers are present behind the tractor, and to know, without any possibility of error, whether the vehicle is being unloaded.

Each RFID transponder, which conventionally includes memory means and radiofrequency transceiver means, can be integrated into a label stuck onto any inside or outside wall of the vehicle, or can be integrated into a box mounted onto any inside or outside wall of the vehicle, or, for the RFID transponders for the rear doors, can be disposed where the two flaps of each of the doors meet. Thus, each time a door is opened, by also opening the antenna circuit of the associated RFID transponder, the RFID transponder is authorized or not authorized to respond to a signal sent by the RFID reader/interrogator of the mobile telephone, and thereby to indicate to said RFID reader/interrogator whether the rear door is in the closed state or in the open state.

The RFID reader/interrogator conventionally comprises transceiver means with an antenna specially adapted to RFID emissions, and a self-powered electronic module comprising a radiofrequency source and electronic components (power supply, modulator, detector, converter, processor unit, and memory, the memory advantageously being shared with the telephone) necessary for storing identification information exchanged between the electronic module and the RFID transponders, and, when said RFID transponders are not of the active type or of the semi-active type (and thus with their own power supply), necessary for powering them remotely. Depending on the memory capacity available in the mobile telephone, the received information can be processed in real time in full or in part in the processor unit of the RFID reader/interrogator or indeed in deferred manner in the management server via the mobile communications network.

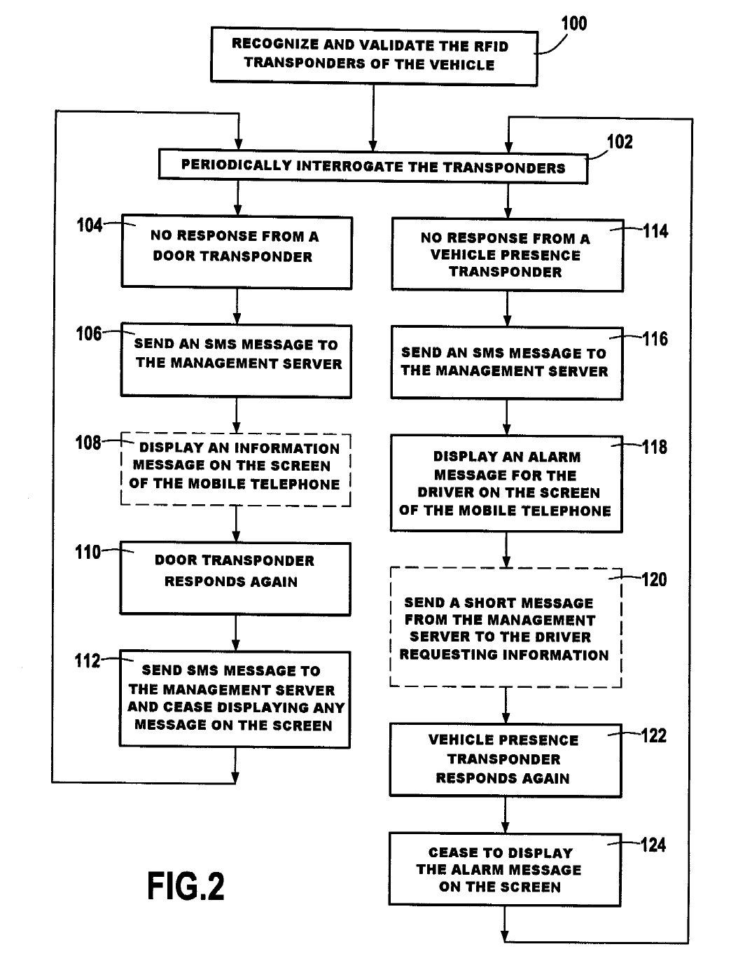

Operation of the communications system of the invention is explained below with reference to FIG. 2 which is a flow chart of the secure tracking method implemented in said system.

Firstly, it should be remembered that each vehicle driver is equipped with a mobile telephone 12 that is specially assigned to said driver, and that includes the software means necessary for controlling the RFID reader/interrogator 12A.

In a first step 100, said software means are initialized and, in particular, e.g. while the vehicle is being loaded, provision is made for the RFID reader/interrogator of the mobile telephone to recognize automatically the RFID transponders within its communication range, and for only those RFID transponders that are associated with the vehicle of the driver having said mobile telephone to be validated. For this purpose, the driver firstly receives a short message indicating a list of the RFID transponders that the driver's telephone should read during the transportation that is assigned to the driver, in order to avoid the driver driving off with the wrong vehicle.

In a step 102, the mobile telephone, as activated in this way, can thus start periodically interrogating the RFID transponders via the RFID reader/interrogator. This interrogation can, for example, be made every five seconds or at a higher frequency. If the loading has been performed properly and, in particular, if the rear doors of the trailers have been closed properly, the mobile telephone receives five signals from respective ones of the five RFID transponders of the vehicle (in the example of the vehicle shown in FIG. 1), and continues to receive the five signals throughout the transportation, from the area in which the goods are loaded to the area in which they are delivered, pending a particular event which is, in principle, no response from one or two RFID transponders corresponding to the rear doors being opened on unloading the goods at the delivery area.

In a step 104, a rear door being opened causes the antenna circuit to be interrupted, e.g. the antenna circuit of the RFID transponder 24B, and thus causes no response from that RFID transponder on being interrogated. That lack of response causes, in the next step 106, a short message, e.g. a Short Message Service (SMS) message, to be sent automatically to the management server which is then informed that the rear door of the vehicle has been opened. In parallel, in a step 108, a “trailer 2 rear door open” indication can be displayed on the screen of the mobile telephone. By re-establishing the above-mentioned antenna circuit, the rear door being subsequently closed causes, in step 110, the RFID transponder to be detected again by the RFID reader/interrogator when that transponder is interrogated again, and correspondingly in step 112 causes a short message to be sent for the attention of the management server, and, when the indication is being displayed, causes said indication to cease to be displayed on the screen of the mobile telephone.

However, in certain particular cases, no response from one or two of the RFID transponders does not result from the rear doors of the vehicle being opened on unloading the goods, but rather results from the vehicle or the trailers of the vehicle leaving the communication range of the mobile telephone, which can be intentional (unloading finished, and change of tractor), or unintentional (the driver moving too far away from the vehicle), or can result from the vehicle as a whole being stolen, or merely its trailers being stolen.

This particular lack of response (step 114) then, in a next step 116, causes a short message to be sent automatically to the management server that is thus informed of the vehicle leaving the communication range or of the trailers being unhitched, depending on which RFID transponders do not respond. In parallel, in a step 118, a “vehicle out of range” or “trailer 2 out of range” or indeed “trailers 1 and 2 out of range” indication, depending on the RFID transponders in question, is displayed on the screen of the mobile telephone, associated if necessary with an audible or vibrating alarm, enabling the driver to react immediately and, e.g. in the event of theft, to inform the authorities very quickly. If the cause is unintentional, e.g. if the vehicle is parked too far away from an eating place chosen by the driver, the driver can also remedy the problem very quickly. The driver coming closer to the vehicle again and the vehicle coming back within the communication range of the mobile telephone (step 122) then causes the corresponding indication on the screen of the mobile telephone to cease to be displayed (step 124).

However, since the “vehicle out of range” information has been sent by SMS to the management server, if the management server, after locating the vehicle by triangulation on the mobile communications network, detects that said vehicle is not at its delivery point at which the trailers are to be unhitched, said management server then, in a step 120 sends a short message to the driver asking for the reason why that information was sent, and exchanges information with the driver, it naturally being possible for that exchange to continue directly by telephone.

Thus, with the invention, haulage companies can locate their fleets of vehicles or can determine in real time when a particular vehicle has been unloaded or reloaded.

It should be noted that, although in the above-mentioned description, the initial recognition of the RFID transponders of a vehicle is performed automatically, it is naturally possible for the codes of the various RFID transponders associated with the vehicle to be input manually into the mobile telephone. Similarly, it should be noted that, although the description refers essentially to heavy goods vehicles with trailers, the present invention can apply to any type of vehicle, and, in particular, to an ordinary commercial vehicle having a driver's cabs and a load-carrying body or unit, or to a container-carrier vehicle having a container with not only a rear delivery door but also a side door, and therefore that has a RFID transponder on each of the doors.

What is claimed is:

1. A secure system for tracking goods loaded on a delivery vehicle having a driver's cab and at least one container, wherein said driver's cab is provided with a first RFID transponder disposed on any wall of said cab, and each of said at least one containers is provided with at least two RFID transponders, one of which is disposed on any wall of said container and the other of which is disposed on each of the delivery doors of said container, each of said RFID transponders being designed to co-operate with a RFID reader/interrogator integrated into a mobile telephone of the driver of the vehicle, said mobile telephone being in communication with a management server via a mobile communications network.

2. A system according to claim 1, wherein said RFID transponder disposed on the delivery door has an antenna circuit mounted where the two flaps of said door meet so as to give information as to whether said door is in an open state or in a closed state.

3. A system according to claim 1, wherein said mobile telephone includes means for automatically sending a short message to said management server, through said mobile communications network, when at least one of said RFID transponders does not respond to interrogation by said RFID reader/interrogator.

4. A system according to claim 2, wherein said interrogation is performed periodically, e.g. every five seconds.

5. A system according to claim 1, wherein said RFID reader/interrogator includes means for automatically recognizing said RFID transponders present within its communication range and for validating only those RFID transponders that are associated with said delivery vehicle.

6. A method of tracking goods loaded on a delivery vehicle having a driver's cab and at least one container, said method comprising the following steps:
periodically interrogating RFID transponders via a RFID reader/interrogator incorporated in a mobile telephone of the driver of the vehicle, a first one of said RFID transponders being disposed on any wall of said cab, and at least two of said RFID transponders being disposed in said at least one container, one of said at least two of said RFID transponders being disposed on any wall of said container and the other of said at least two of said RFID transponders being disposed on each of the delivery doors of said container; and
automatically sending a short message to a management server, through a mobile communications network when at least one of said RFID transponders does not respond to said periodic interrogation by said RFID reader/interrogator.

7. A method according to claim 6, wherein said short message corresponds to at least one of the following messages: “trailer rear door open”, “vehicle out of range”, or “trailer(s) out of range”.

8. A method according to claim 6, further comprising an additional step of causing the management server to send an information request short message to the mobile telephone of the driver of said vehicle after said short message indicating that the vehicle or at least one container is out of range has been received.

9. A method according to claim 6, further comprising an initial step for automatically recognizing said RFID transponders present within the communication range of said RFID reader/interrogator and for validating only those RFID transponders that are associated with said delivery vehicle.

10. A method according to claim 9, wherein in said initial step, the driver receives a short message indicating to the driver the list of the RFID transponders that the driver's telephone should read in said periodic interrogation step.
